(19) United States
(12) Patent Application Publication
(10) Pub. No.: US 2015/0086823 A1
(43) Pub. Date: Mar. 26, 2015

(54) NON-WELDED BATTERY MODULE

(71) Applicant: Chung Peng Liew, Penang (MY)

(72) Inventor: Chung Peng Liew, Penang (MY)

(21) Appl. No.: 14/384,833

(22) PCT Filed: Mar. 12, 2012
(86) PCT No.: PCT/MY2012/000050

§ 371 Date: Sep. 12, 2014

(51) Int. Cl. H01M 2/10; H01M 2/20

(52) U.S. Cl. CPC H01M 2/1083; H01M 2/206; H01M 2220/20
USPC 429/99

(57) ABSTRACT

This invention relates to an improvement in battery packs. The present invention resides in a combination of an electric battery pack and a apparatus for making an electrical connection to the battery without involving the spot welding process. The present assembly method enables terminal blocks containing multiple battery packs joint in series having a “U-turn” configuration without external electrical connection. Any two battery packs are firmly locked together through the pressure plates (200) without being electrically connected together. The present embodiment uses two separate nickel or other conductive material plated copper sheets (113a or 113b) that are embedded between the battery cell holder (114a, 114b) and the silicone rubber pressure sheet (112a, 112b). The first end portion block of battery packs supported by an end pressure plate (300) can be connected together to the second end portion of the block battery packs by using a modified nickel or other conductive material plated copper sheet (113) that enable the two battery packs to be connected internally, thus, making the “U-turn” configuration possible. This method is one of the most cost efficient ways to connect internally, to avoid using any external wires or circuits, which eventually maintain the internal resistance of each of the battery packs.

### BACKGROUND OF THE INVENTION

The battery is the most important part in the Electric Vehicle (EV). The most promising battery technology today for the EV industry is Lithium Battery, especially the cylindrical Li-Ion (Lithium Ion) cell. Compare to the battery pack use in the computer notebook or similar size battery pack, the battery pack use in EV is much bigger, and therefore the process to make the pack is much complicated and costly if any defect were to occur during the assembly process. The definition of battery end of life in EV battery pack is about 70% energy left compare to the new battery pack. The battery cells from this end of life battery pack are still useful in other application like power grid energy buffer or solar energy storage where space is no longer a concern compared to in the EV. The substantial amount of heat generated from battery cell that increases temperature in the battery pack is a common problem in all Lithium batteries, therefore exists a pressing need to disperse the heat out from the cell.

The conventional way of assembly is to use spot welding to connect copper sheet to the battery cells, the alternative method is to use pressure to maintain the contact of the nickel or other conductive material coated copper sheet to the battery cell without spot welding. These methods supposedly were successful in bringing the heat out from the battery cell while still maintain the electrical insulation.

However, the conventional methods are not without its drawbacks. A major drawback for spot welding technology is the cell will not be able to be reused once the spot weld assembly process is completed, therefore the production process is extremely critical because there is no second chance once spot weld error occurs. The end of life battery cell will not be able to recycle due to the welded surface with copper sheet.

The other drawbacks for spot welding technology is the high maintenance cost as a special spot welding machine is required. Spot welding process is labour intensive.

Thus, the manufacturers should pay attention to improving the simplicity and efficiency of assembling battery modules to lower the maintenance cost and increase the economic benefits.

### SUMMARY OF THE INVENTION

Specifically, it is an object of the present invention to provide an alternative method of assembling cylindrical battery including but not limited to Lithium Ion (Li-Ion) cell or battery pack assembly without welding or soldering requiring an excessive amount of time and skilled technique, thereby simplifying the assembly process of a battery pack and reducing the manufacturing time of the battery pack, and therefore, decreasing the manufacturing costs of the battery pack.

Accordingly, a non-spot welding battery assembly is a revolutionary method whereby no spot welding machine is required during the assembly process, thereby enabling efficient and effective manufacturing anywhere in the world.

Another advantage of the present invention is to provide the possibility reusing and recycling battery cell as there involves no spot welding mark on the battery cell.

It is another object of the present invention to provide a battery pack including whereby the structural stability of the battery pack is improved.

The present invention resides in a combination of an electric battery pack and a apparatus for making an electrical connection to the battery without involving the spot welding process. The apparatus includes conductive members, nickel or other conductive material plated copper sheet secured to a conductive battery terminal exposed at an external surface of the battery and a pressure plate connected to an electrically insulating material namely silicone rubber sheet and wherein the conductive terminal namely negative and positive terminal are encapsulated in the said electrically insulating material which is substantially self-sealing when compressed.

Preferably, the encapsulant is contained pressure on said external surface of the battery cell so as to enclose said terminal and said conductive member and which is formed in one wall with an aperture aligned with said terminal.

In a preferred embodiment, the battery cell is affixed within battery cell holder and the nickel or other conductive material coated copper is directly pressed on the cell from both end to form the contact. The pressure comes from the compressed silicone rubber sheet with the pressure spot at both end of the battery cell. The silicone rubber sheet with the spot is able to provide sufficient pressure to form a good contact in between nickel or other conductive material coated copper sheet and battery cell. The silicone rubber sheet is selected because it is compressible, good electrical insulation, and heat conductive. However, the present invention does not limit to the use of silicone rubber. Other material which carries the same effect and properties as silicone rubber may be employed by way of the present invention.

In the preferred embodiment, the battery cell holder is to hold the battery cell wherein the battery cell holder has through holes connected to the conductive terminals; negative and positive terminal battery cell.

The present invention also provides Aluminum or other material like plastic, but not limited to, heat sink casing mounted on to the battery cell having the role of dissipating the heat. The aluminum or other material like plastic, but not limited to, heat sink casing provides a plurality of rivet slots to enable rivets to be fastened to form rigid support to the battery cell.

In the above described structure under the present embodiment, this battery pack assembly accommodates multiple battery pack joint in series in one row and the other seven battery pack joint in series in another row, therefore making two blocks of battery packs containing seven battery packs in each row. The terminal end one of block is connected to second end block by providing having a U-turn configuration.

In the above described structure, it should be understood when the battery cells have been contained in the battery cell containing part and the battery cell holder have been attached to the apparatus, the first terminal block will be pressure fitted to the corresponding terminals of the apparatus enabling the power to be supplied from the battery pack to the body of the apparatus. When the apparatus has started to be driven, electric current will flow from the battery cells to the body of the apparatus through the first terminals, whereby the power will be supplied to the body of the apparatus.

Under the present embodiment of the invention, the voltage of the complete battery pack can be increased by adding on the battery pack in series.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an exploded view of the battery pack illustrating the full assembly battery pack assembly according to the present embodiment.

FIG. 1a shows the complete structure of one negative terminal block of a single battery pack

FIG. 1b shows the complete structure of one positive terminal block of a single battery pack

FIG. 2 shows the positioning of the silicone rubber sheet coupled with the built-in water proof seal in which the conductive terminals (negative and positive terminals) are encapsulated within the battery pack assembly which has an Aluminum or other material like plastic, but not limited to, heat sink casing coupled with rivet engagement slots, the location of the battery cell holder, balance pin point and the connectors.

FIG. 3a shows the example configuration of a complete structure of few battery packs in series mode.

FIG. 3b shows the example configuration of a complete structure of few battery packs in series mode, arranged in parallel to double the power supply.

FIG. 4a shows a matrix of configuration structures of battery packs in series and reinforcement slabs to hold the battery packs together and the end terminal slab is connected from the end of the battery packs to the second end block by providing an adjoining U-turn after having the positive and negative terminal plugged in respectively.

FIG. 4b shows the end block that are connected with an internal nickel or other conductive material plated copper sheet (combined of two single nickel or other conductive material plated copper sheet) without external connection make U turn possible with minimum cost.

### DETAILED DESCRIPTION OF THE PREFERRED EMBODIMENT

The preferred embodiments of the present invention will be described in detail with reference to the accompanying drawings. It should be noted, however, that the scope of the present invention is not limited by the illustrated embodiments.

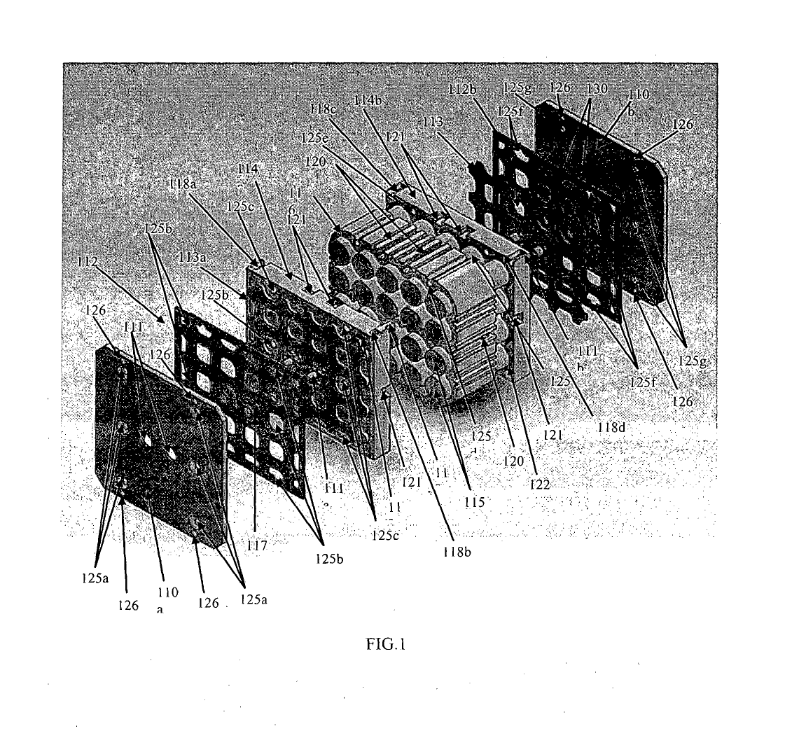

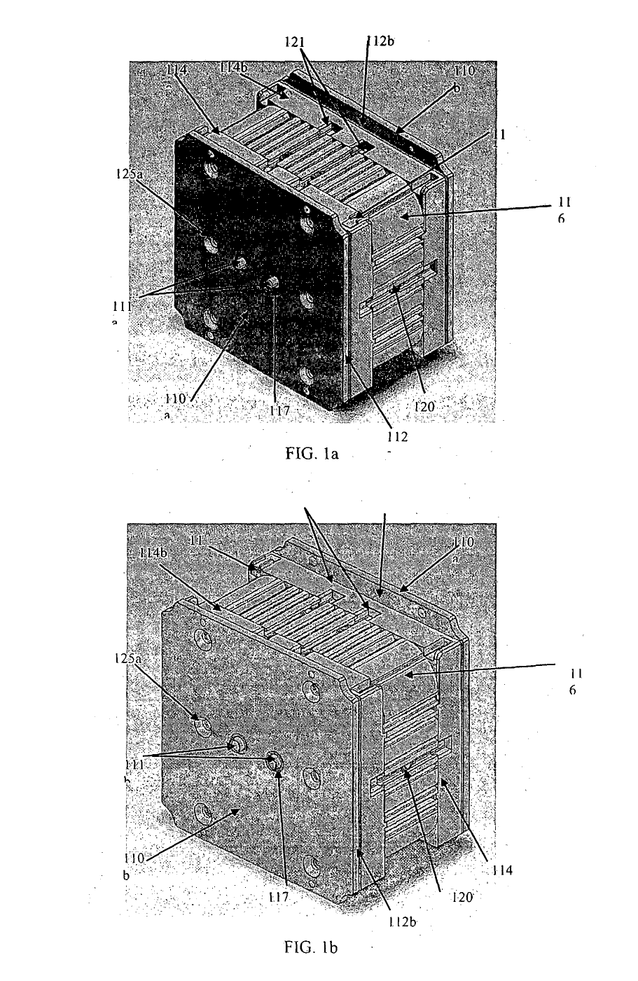

Referring to FIG. 1 is the exploded view the overall battery pack assembly. First is the negative pressure plate (110a), followed by the negative silicone rubber pressure sheet (112a) and negative nickel or other conductive material plated copper sheet (113a) that is connected with the negative terminal (111a). The negative battery cell holder (114a) that holds the battery cells (115) through the Aluminum or other material like plastic, but not limited to, heat sink casing (116) can be seen. On the other end of the battery cells (115) is the positive side of the terminal that is connected to the positive battery cell holder (114b) followed by the positive nickel or other conductive material plated copper sheet (113b) that is connected with the positive terminal (111b) followed by the positive silicone rubber pressure sheet (112b) and positive pressure plate (110b).

The first part of the battery pack consists of a negative terminal (111a), which is connected to the front side of the nickel or other conductive material plated copper sheet (113a), going through the waterproof seal (117) from the backside of the negative silicone rubber pressure sheet (112a) that has pressure spots (130) that help applying uniform pressure spots across the nickel or other conductive material plated copper sheet (113a), to ensure proper placement towards the battery cell holder (114a). Besides the pressure spots (130), the silicone rubber pressure sheet (112a) also comes with water proof seals (117) in one whole silicone rubber pressure sheet (112a). The function of the waterproof seals (117) is to enable the negative terminal (111a) to go through the seals (117) and prevent any moisture from oxidizing the negative terminal (111a) and nickel platted copper sheet (113a) or even getting into the battery pack. The number of terminal rods (111a) in this case is not limited to two, which is illustrated in the embodiment. The number of the terminal rods (111a) can be reduced or increased depending on the electric current needed for the applications or specifications.

The negative nickel or other conductive material plated cooper sheet (113a) is connected to the balancing wire (119) that is connected to a connector (118) through the slot (118b) situated at the end of the negative battery cell holder (114a). The balance wire (119) is use as a feedback to the battery console during charge-recharge to ensure all battery packs are at the same potential voltage in order to have balance load across all battery packs and improve battery efficiency as a whole. It is to be understood from the present embodiment, the balancing wire (119) and the connector (118) may be connected through either the negative battery cell holder (114a) or the positive battery cell holder (114b) respectively through the available slots (118a, 118b, 118c, and 118d). The position of the connector is not limited to one location, which can be as in many locations and shapes, depending on application or specification.

The negative battery cell holder (114a) is designed to hold the battery cell (115) that comes with waterproof seal along each battery cells. The positive battery cell holder (114b) is the mirror image of the negative battery cell holder (114a) that serves the same purpose, which has the same waterproof seal (122) design. The purpose of the waterproof seal (122) is to prevent any water or moisture from penetrating into the cell, resulting corrosion or short circuit in the field. Once the whole battery pack is screwed or riveted, both the negative battery cell holder (114a) and positive battery cell holder (114b) will protect the cell through the waterproof seal (122) and the Aluminum heat sink holder (116).

The battery cells (115) is not limited to twenty cells (a five by four array configuration) as illustrated in the embodiment, the design and configuration of the battery cells (115) can be of any number or array, depending on application or specification.

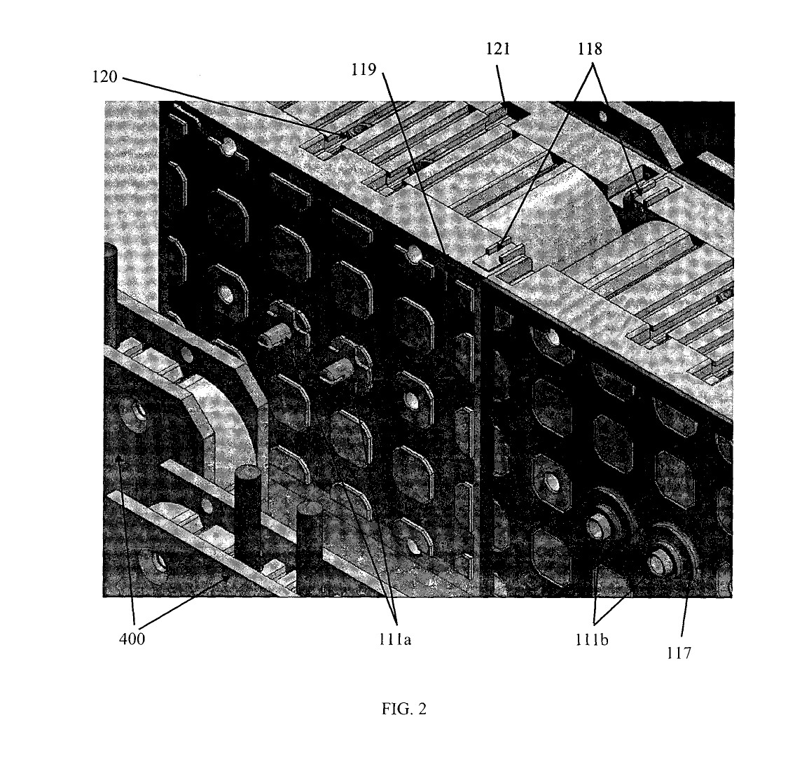

The Aluminum heat sink holder (116) is designed to fit all battery cells (115) according to the configuration or array, in this case is a five by four array configuration. The main purpose of the Aluminum heat sink (116) is to dissipate heat outside of the battery cell, away from the battery pack. In order to ensure all the battery cells (115) are in the optimum stage, the heat needs to be dissipated as much as possible, to avoid over heating in any of the battery cells in such array configuration. Beside for heat dissipation, the outer design of the Aluminum heat sink holder (116) is also used as an external battery pack holder. With the combination of the negative battery cell holder (114a), Aluminum or other material like plastic, but not limited to, heat sink casing (116) and the positive battery cell holder (114b), there is a plurality of opening for nut inlets (121) located at all sides of the negative battery cell holder (114a) and the positive battery cell holder (114b). These nut inlets (12.1) enable the nuts (120) to be inserted and position them along the Aluminum or other material like plastic, but not limited to, heat sink casing (116). These nuts (120) will then be used in the field, if external holder or supporting structure is needed and can be mounted directly to the battery packs through the Aluminum or other material like plastic, but not limited to, heat sink casing (116). Detailed and enlarged figure of such configurations is shown in FIG. 2.

The back of the positive battery cell holder (114b) is now fit to the positive nickel or other conductive material plated copper sheet (113b) where the positive terminal (111b) is connected and assembled through the positive silicone rubber sheet (112b) and through the waterproof seal (117) and to the positive pressure plate (110b).

The assembly is completed by connecting the battery packs from the negative pressure plate (110a) to the positive pressure plate (110b) by screwing or riveting through the holes 125a, 125b, 125c, 125d, 125e, 125f and 125g respectively. FIG. 1a shows the negative side of the assembled battery pack and FIG. 1b shows the positive side of the assembled battery pack.

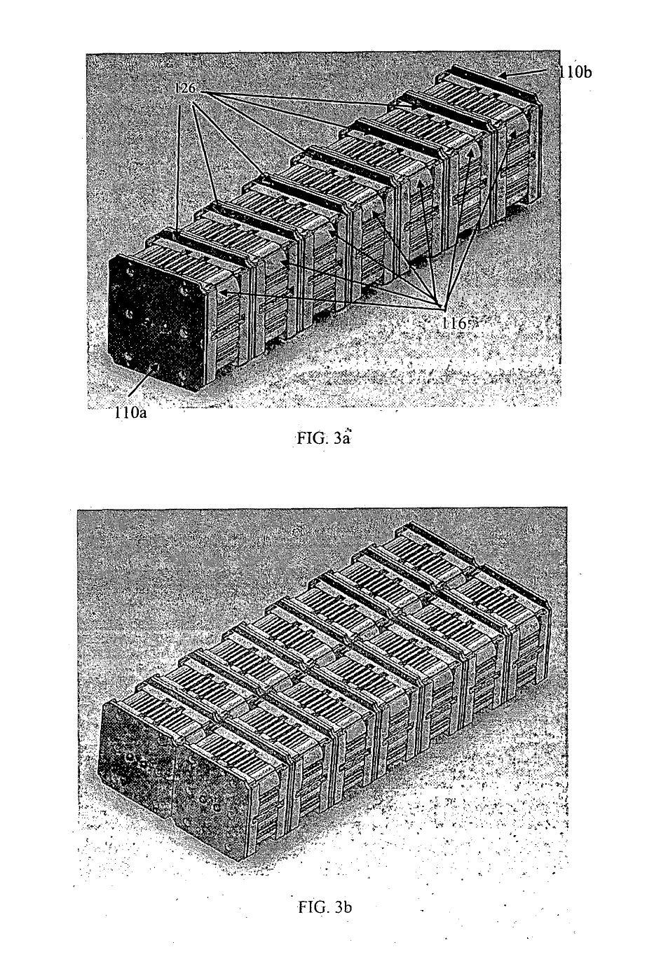

Each battery pack, with negative terminal (111a) and positive terminal (111b) can be joint in any number of battery packs, depending on the application or specification. Every battery pack is connected in series and locked through the screw locations (126) located in both negative pressure plate (110a) and positive pressure plate (110b), as configuration is illustrated in FIG. 3a.

When multiple battery packs are connected together, this will increase the voltages and able to supply more current to the application. FIG. 3a illustrated how a series of battery packs (seven packs, in this exemplary figure) are joint in series through the terminals and holding them together through the screw locations (126) located in all negative pressure plate (110a) and positive pressure plate (110b). FIG. 3b shows the example configuration of a complete structure of few battery packs in series mode, arranged in parallel to double the power supply.

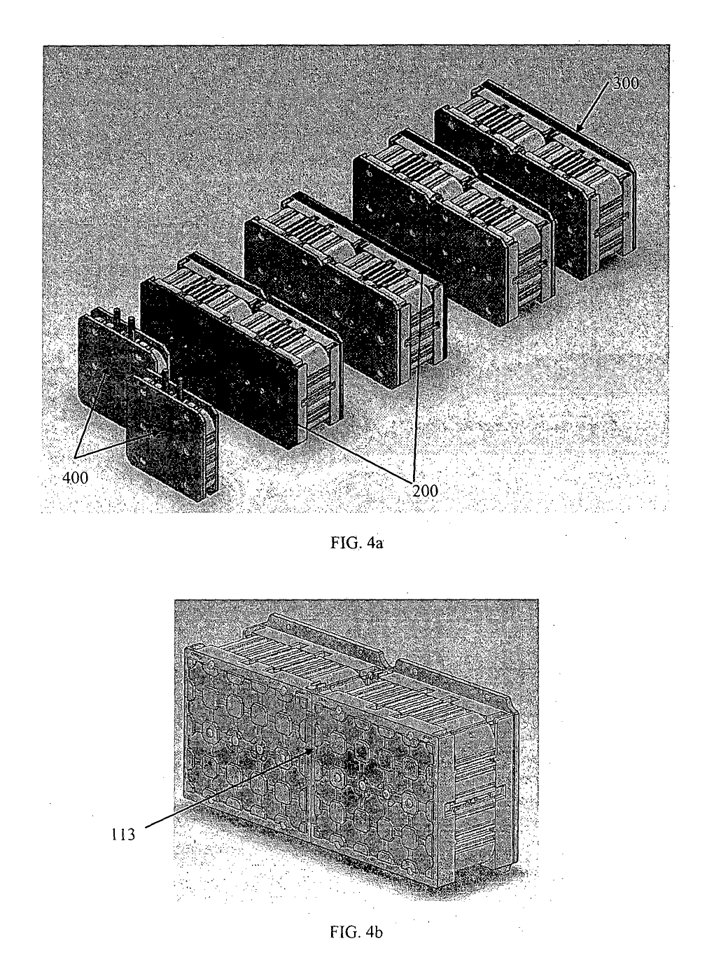

FIG. 4a shows another illustration on how first block terminal end of battery packs containing multiple battery packs are joint in series and extending to the second block terminal end by configuring a “U-turn” without external electrical connection. Any two battery packs are firmly locked together through the pressure plates (200) without being electrically connected together. The present embodiment uses two separate nickel or other conductive material plated copper sheets (113a or 113b) that are embedded between the battery cell holder (114a, 114b) and the silicone rubber pressure sheet (112a, 112b). The first end portion block of battery packs supported by an end pressure plate (300) can be connected together to the second end portion of the block battery packs by using a modified nickel or other conductive material plated copper sheets (113), which is illustrated in FIG. 4b, that enable the two battery packs to be connected internally, thus, making the “U-turn” configuration possible. This method is one of the most cost efficient ways to connect internally, to avoid using any external wires or circuits, which eventually maintain the internal resistance of each of the battery packs. Both terminals (111a and 111b) are connected through the terminal blocks (400) to have better accessibility to the positive and negative terminals in the application or specification.

1.-12. (canceled)

13. A battery pack for making an electrical connection without involving spot welding, wherein terminal blocks contain multiple battery packs joined in series having a U-turn configuration without external electrical connections, wherein any two battery packs are locked together through pressure plates in which two separate nickel or other conductive material plated copper sheets are embedded between a battery cell holder and silicone rubber sheets, comprising:
two blocks of battery packs joined in series, each of the battery pack cells in a first block and second block including a main conductive negative pressure plate coupled with a contact portion negative terminal at one end and positive pressure plate coupled with a contact portion positive terminal at another end, conductive members including a nickel or other conductive material plated copper sheets and an electrically insulating material which is the silicone rubber sheets, a negative battery cell holder, a positive battery cell holder and a battery cell.

14. The battery pack as claimed in claim 13, wherein the negative terminal is connected to the negative nickel or other conductive material plated copper sheet, going through a waterproof seal from the negative silicone pressure sheet that has pressure spots.

15. The battery pack as claimed in claim 14, wherein the negative nickel or other conductive material plated copper sheet is connected to a balancing wire, wherein the balancing wire is connected to a connecter through a slot situated on an end portion of the said negative battery cell holder.

16. The battery pack as claimed in claim 15, wherein the balancing wire and the connector are connected through the negative battery cell holder and the positive battery cell holder through a plurality of slots.

17. The battery pack, as claimed in claim 13, wherein the negative battery cell holder holds the battery cells and a heat sink casing functions as an external battery pack holder.

18. The battery pack as claimed in claim 17, wherein there is a plurality of openings for nut inlets located at all sides of the negative battery cell holder and the positive battery cell holder, wherein the nut inlets enable the nuts to be inserted and positioned along an aluminum or plastic material formed on the heat sink casing.

19. The battery pack as claimed in claim 18, wherein a back portion of the positive battery cell holder is securely fitted to the positive nickel or other conductive material plated copper sheet, wherein the positive terminal is connected through the positive silicone rubber sheet and waterproof seal to the positive pressure plate.

20. The battery pack as claimed in claim 13, wherein the battery packs are connected together from the negative pressure plate all the way to the positive pressure plate by riveting through a plurality of holes.

21. The battery pack as claimed in claim 13, wherein the two blocks containing multiple battery packs are joined in series, wherein a first block terminal end extends to a second block terminal end by having a U-turn configuration without an external electrical connection and using a modified nickel or other conductive material plated copper sheets.

22. The battery pack as claimed in claim 20, wherein any two battery packs are firmly locked together by the pressure plates.

23. The battery pack as claimed in claim 21, wherein two separate nickel or other conductive material plated copper sheets are embedded between at least one of the battery cell holders and at least one of the silicone rubber pressure sheets.

24. The battery pack as claimed in claim 22, wherein a first end portion block of the battery pack is supported by an end pressure plate that is connected together to a second end portion block of the battery pack, wherein the connection is facilitated by using a modified nickel or other conductive material plated copper sheet that enables the battery packs to be connected internally to facilitate the U-turn configuration without the use of external wiring and circuits.
